(19) United States
(12) Patent Application Publication
(10) Pub. No.: US 2023/0035510 A1
(43) Pub. Date: Feb. 2, 2023

(54) UTILITY KNIFE AND DEFENSIVE WEAPON

(71) Applicant: Troy D Defenbaugh, Waukesha, WI (US)

(72) Inventor: Troy D Defenbaugh, Waukesha, WI (US)

(21) Appl. No.: 17/876,885

(22) Filed: Jul. 29, 2022

Related U.S. Application Data
(60) Provisional application No. 63/200,711, filed on Aug. 2, 2021.

(51) Int. Cl. B25G 1/10; B26B 3/00; F41B 13/08

(52) U.S. Cl. CPC B25G 1/102; B26B 3/00; F41B 13/08

(57) ABSTRACT

A knife includes a single flat right triangle like steel blade with a pointed apex and sharp-edged sides with an apex height shorter than the length of its base. The knife also includes an elongated handle integral with the blade and formed along a hand wide hypothenuse base. The handle has two spaced apart finger openings in the handle, one adapted to allow a user's little finger and ring finger to pass through the finger opening and the other adapted to allow a user's middle finger and index finger to pass through the finger opening. The apex of the blade is adapted to be positioned over the middle finger of the user.

### BACKGROUND

This disclosure pertains to a utility knife, and, more particularly, to a utility knife that can be used as a defensive weapon.

It is known to provide long single blade punch daggers with handles, some of which have blades offset from the center of the handle. Such daggers, however, require precision in use of the dagger, for if the blade point misses its target, the dagger is less effective as a defensive weapon. Further, such daggers are not very effective if swept across a target, for the point must be at a certain depth in the target to be effective. Furthermore, if the long blade enters its target at angle, the dagger punch is less effective.

What is needed is a knife like a punch dagger that requires less precision when hitting its target, exposes more blade edge when the knife is swept across its target, and which provides maximum force when punched forward. It would also be beneficial if such a defensive weapon could also be used as a utility knife.

### SUMMARY

Disclosed is a knife including a single triangle like steel blade with a pointed apex and sharp-edged sides and a hand wide base. The knife also includes an elongated handle attached directly along its length to the base, the handle having at least one finger opening adapted to allow at least one of a user's fingers to pass through the finger opening.

The exposed sharp edges on either side of the point assists with defensive use of the knife. When the knife is swung by a user to sweep an arc through the air, a maximum amount of sharp edge is presented. In the event of any attacker being in the area, the knife will slice as it sweeps through the arc, cutting anyone who might be in the vicinity. The shallow point of the knife also allows for the knife to be used for opening boxes, slicing fruit, or cutting through various materials, for example.

### BRIEF DESCRIPTION OF THE DRAWINGS

FIG. 1 is a top view of a knife according to this disclosure. The knife in this view does not include a handle form.

FIG. 2 is a top perspective view of the knife shown in FIG. 1, with a handle form added to the knife handle.

FIG. 3 is a rear perspective view of the knife in FIG. 2.

FIG. 4 is front perspective view of the knife in FIG. 2.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

### DESCRIPTION OF A PREFERRED EMBODIMENT

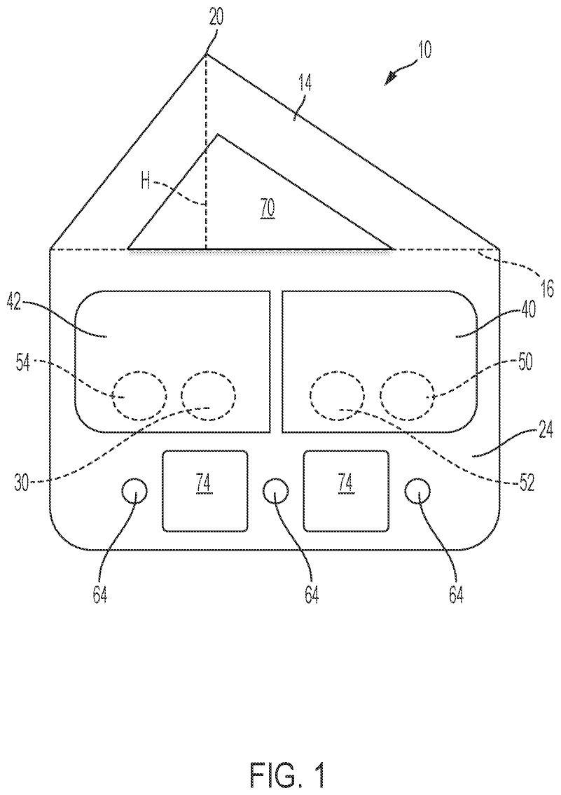

As illustrated in FIGS. 1-4, a utility knife and defensive weapon 10 includes a single flat right triangle like steel blade 14 with a hand wide hypothenuse base 16. The blade 14 has an apex 20 height shorter than the length of its base 16. The apex 20 is a sharp point and both blade edges that lead up to the apex have a sharp edge formed by bevels 18 and 19 (see FIG. 4) on the entire length of the opposite sides of the blade edge. In other less preferred embodiments (not shown), a bevel on just one side of the blade edge can be used. The knife 10 also includes an elongated handle 24 integral with the blade 14 and formed along the blade base 16, the handle 24 forming a rectangle like shape. In other embodiments (not shown), other handle shapes can be used. The blade apex 20 is adapted to be positioned over the middle finger 30 of a user.

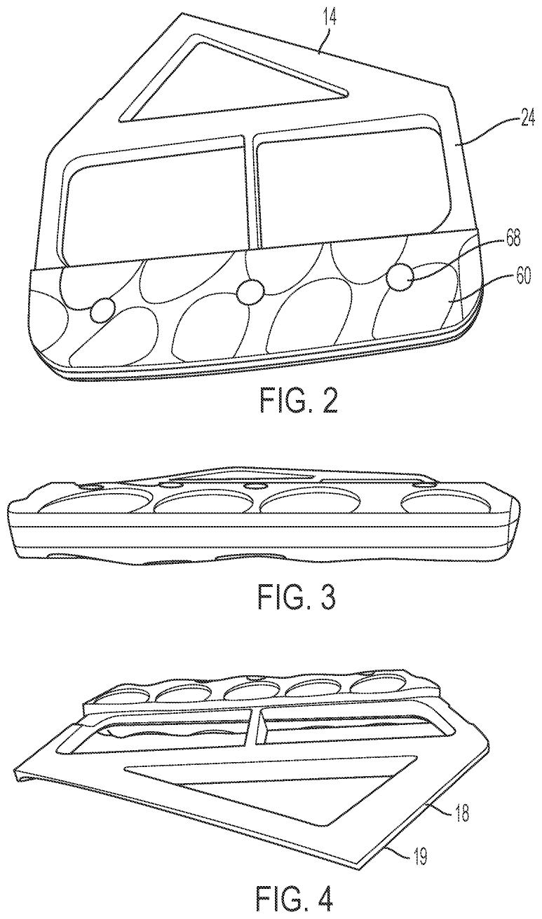

More particularly, in the illustrated embodiment, the right-angle apex 20 is 2 inches high (see H in FIG. 1) from the base 16, the base 16 is 4.5 inches long and the apex 20 is 1.5 inches from the left side 34 of the blade 14. In other less preferred embodiments (not shown), other dimensions can be used. There are two spaced apart finger openings 40 and 42 in the handle 24, one finger opening 40 adapted to allow a user's little finger 50 and ring finger 52 to pass through the finger opening 40. The other finger opening 42 is adapted to allow a user's middle finger 30 and index finger 54 to pass through the finger opening 42. The steel between the finger holes 40 and 42 adds rigidity to the blade 14. In other less preferred embodiments (not shown) a single finger hole can be used. In the illustrated embodiment, the knife 10 also includes a handle form 60 (see FIGS. 2-4) attached to the handle 24. The handle form 60 is adapted to fit in the palm (not shown) of a user.

In other embodiments (not shown), the handle can be separate from the blade and elongated and attached to the blade base along the handle length. In other embodiments (not shown), the edge of the handle and handle form adjacent the finger openings have scallops that receive a user's fingers.

To aid in the attachment of the handle form 60 to the handle 24, the handle 24 has three spaced apart holes 64 through which screws 68 can pass to hold the two sides of the handle form 60 together. There is also a large triangular opening 70 in the blade 14 and spaced apart holes in the handle 74 for reducing the weight of the blade 14.

“Hand wide” as used herein means wide enough to reach across the knuckles of the little, ring, middle, and index fingers of an adult hand, i.e., greater than 3 inches, but preferable 4.5 inches with the finger openings being 4 inches wide.

The knife 10 can be held in the hand in a position where the point of the triangular like blade aligns with the bones of the forearm. As a result, a thrust of the knife forward provides maximum force on the point the knife. The exposed sharp edges on either side of the point assists with defensive use of the knife. When the knife is swung by a user to sweep an arc through the air, a maximum amount of sharp edge is presented. In the event of any attacker being in the area, the knife will slice as it sweeps through the arc, cutting anyone who might be in the vicinity. The shallow point of the knife also allows for the knife to be used for opening boxes, slicing fruit, or cutting through various materials, for example.

Various other features of this disclosure are set forth in the following claims.

1. A knife including a single triangle like steel blade with a pointed apex and sharp-edged sides and a hand wide base and an elongated handle attached directly along its length to the base, the handle having at least one finger opening adapted to allow at least one of a user's fingers to pass through the finger opening.

2. The knife according to claim 1 wherein the blade is formed like a right-angle triangle with the base as the hypothenuse.

3. The knife according to claim 1 wherein the blade has an apex height shorter than the length of its base.

4. The knife according to claim 1 wherein the apex of the blade is offset from the sides of the blade

5. The knife according to claim 1 wherein the apex of the blade is offset from the center of the base of the blade.

6. The knife according to claim 1 wherein the handle is formed as an integral part of the blade.

7. The knife according to claim 1 wherein the knife also includes a handle form attached to the handle.

8. The knife according to claim 7 wherein the handle form is adapted to fit in the palm of the user.

9. The knife according to claim 1 wherein the blade is flat.

10. The knife according to claim 1 wherein the handle has two spaced apart finger openings in the handle, one adapted to allow a user's little finger and ring finger to pass through the opening and the other adapted to allow a user's middle finger and index finger to pass through the opening.

11. A knife including a single flat triangle like steel blade with a pointed apex and sharp-edged sides and a hand wide base and an elongated handle attached directly along its length to the base, the handle having at least one finger opening adapted to allow at least one of a user's fingers to pass through the at least one opening, wherein the apex of the blade is adapted to be positioned over the middle finger of the user.

12. The knife according to claim 11 wherein there are two spaced apart finger openings in the handle, one adapted to allow a user's little finger and ring finger to pass through the opening and the other adapted to allow a user's middle finger and index finger to pass through the opening.

13. The knife according to claim 11 wherein the blade is formed like a right-angle triangle with the base as the hypothenuse.

14. The knife according to claim 11 wherein the blade has an apex height shorter than the length of its base.

15. The knife according to claim 11 wherein the handle is formed as an integral part of the blade.

16. The knife according to claim 11 wherein the knife also includes a handle form attached to the handle.

17. The knife according to claim 16 wherein the handle form is adapted to fit in the palm of the user.

18. A knife including a single flat right triangle like steel blade with a pointed apex and sharp-edged sides with an apex height shorter than the length of a hand wide hypothenuse base, and an elongated handle integral with the blade and formed along the blade base, the handle having two spaced apart finger openings in the handle, one adapted to allow a user's little finger and ring finger to pass through the finger opening and the other adapted to allow a user's middle finger and index finger to pass through the finger opening, with the apex of the blade is adapted to be positioned over the middle finger of the user.

19. The knife according to claim 18 wherein the knife also includes a handle form attached to the handle.

20. The knife according to claim 19 wherein the handle form is adapted to fit in the palm of the user.
